(19) United States
(12) Patent Application Publication
(10) Pub. No.: US 2016/0320209 A1
(43) Pub. Date: Nov. 3, 2016

(54) METHOD AND POSITION SENSOR ARRANGEMENT FOR DETERMINING THE MUTUAL LOCATION OF A FIRST OBJECT AND A SECOND OBJECT

(71) Applicant: FREEVALVE AB, Ängelholm (SE)

(72) Inventor: Anders HOGLUND, Munka Ljungby (SE)

(21) Appl. No.: 15/105,205

(22) PCT Filed: Dec. 19, 2014
(86) PCT No.: PCT/SE2014/051541

§ 371 Date: Jun. 16, 2016

(30) Foreign Application Priority Data
Dec. 20, 2013 (SE) 1351568-9

(51) Int. Cl. G01D 5/20

(52) U.S. Cl. CPC G01D 5/2006

(57) ABSTRACT

A method and a position sensor assembly for determining a mutual position between a first object (1) and a second object (2). The position sensor assembly includes a first body (3), a second body (4), a control unit, and a sensor circuit, the first body (3) and the second body (4) being mutually displaceable in relation to each other and the second body (4) presenting an unambiguous inductance value for each mutual position between the first body (3) and the second body (4). The sensor circuit includes in its turn a comparator connected to a first branch including the second body (4), a power switch and a measuring resistance connected in series with each other.

### TECHNICAL FIELD OF THE INVENTION

The present invention relates generally to a method and position sensor assembly for determining a mutual position between a first object and a second object. In particular, the present invention relates to a method and position sensor assembly for determining a mutual position between for instance a first arm/bar and a second arm/bar which are turnably connected to each other in for instance an assembling robot or machine.

The position sensor assembly comprises a first body, a second body, a control unit and a sensor circuit, said first body and said second body being mutually displaceable in relation to each other and said second body presenting an unambiguous inductance value for each mutual position between said first body and said second body. The sensor circuit comprises in turn a comparator connected to a first branch comprising said second body, a power switch and a measuring resistance coupled in series with each other.

Herein, the present invention will be described in connection with the determination of mutual position between a first arm/bar and a second arm/bar without being limited thereto; for instance, the present invention may be used for determining mutual position between different segments of an arm in an assembling robot or machine, or the like, where positioning of objects having high speed has to be made with high precision.

### BACKGROUND OF THE INVENTION AND PRIOR ART

Position sensor assemblies arranged to determine/follow the position of a first object in relation to a second object are known since long. Early variants of position sensor assemblies were, however, not sufficiently fast and exact to be usable in connection with objects moving at very high speed, such as arm segments/bars of an assembling robot or of a “pick and place” robot. In the industry, there are additional requirements that the systems to be used should be robust and have great reliability at minimal cost. In recent years, systems have appeared that comprise a stationary coil/inductor that interacts with a movable body manufactured from an electrically conductive material, said movable body being connected to a valve of a combustion engine and moving together therewith.

See, for instance, U.S. Pat. No. 7,032,549, which discloses a position sensor assembly comprising an oscillator, a first body, a coil, a control unit, and a sensor circuit, said first body being reciprocally displaceable in the axial direction in relation to and externally of said coil. The sensor circuit comprises in turn a comparator connected to a first branch comprising said coil, an oscillator, and a measuring resistance coupled in series with each other. When the coil is energized, it is arranged to generate an oscillating magnetic field, which in turn induces eddy currents in the displaceable body, which causes the coil to be short-circuited. The degree of short circuit of the coil changes proportionally to the change of the mutual overlap between the coil and the body. Then the comparator determines the position of the valve based on the phase shift between the supply voltage of the oscillator and the voltage across the measuring resistance, the phase shift increasing with increasing overlap between the coil and the body.

However, said position sensor assembly is impaired by the disadvantage that the same comprises an oscillator, or a similar signal generator that provides an alternating voltage signal, which, relatively speaking, is energy demanding since the oscillator continuously is in operation. Furthermore, said method comprises partly analog signals, which entails that the mutual position only can be determined with, relatively speaking, low time and location resolution.

### BRIEF DESCRIPTION OF THE OBJECTS OF THE INVENTION

The present invention aims at obviating the above-mentioned disadvantages and failings of previously known position sensor assemblies and at providing an improved method and position sensor assembly for determining a mutual position between a first object and a second object. A primary object of the invention is to provide an improved method and position sensor assembly of the type defined by way of introduction, wherein the determination of the mutual position can be carried out with high precision and simultaneously low energy consumption.

Another object of the present invention is to provide a method that enables selectable distance between mutually isolated determinations of the mutual position.

It is another object of the present invention to provide a position sensor assembly that is entirely digitized, which gives a simple and inexpensive solution that still enables the determination of the mutual position with high precision.

It is another object of the present invention to provide a position sensor assembly that is robust and contact free.

It is another object of the present invention to provide a position sensor assembly that comprises few and inexpensive components.

### BRIEF DESCRIPTION OF THE FEATURES OF THE INVENTION

According to the invention, at least the primary object is achieved by means of the method and the position sensor assembly that are defined by way of introduction and have the features defined in the independent claims. Preferred embodiments of the present invention are furthermore defined in the depending claims.

According to a first aspect of the present invention, a method is provided of the type defined by way of introduction, which comprises the steps of:
sending an upflank of a digital input signal pulse from the control unit to the power switch to produce a state change of the power switch from open to closed,
in the control unit, detecting a first state change of an output signal from the comparator, and
determining a mutual position between said first body and said second body based on the delay between the upflank of the input signal pulse and the first state change of the output signal,
   or comprises the steps of:
sending an upflank of a digital input signal pulse from the control unit to the power switch to produce a state change of the power switch from open to closed,
in the control unit, detecting a first state change of the output signal from the comparator,
in the control unit, detecting a second state change of said output signal, and
determining a mutual position between said first body and said second body based on the delay between the first state change of the output signal and the second state change of the output signal.
   According to a second aspect of the present invention, a position sensor assembly is provided, the sensor circuit of which comprises:
a first branch comprising said second body, a measuring resistance, and a power switch having an input operatively connected to said control unit for receiving individual digital input signal pulses, and
a comparator, which is connected to said first branch via a first input to obtain an instantaneous measuring voltage across the measuring resistance, and which further comprises a second input for obtaining an instantaneous reference voltage, and an output operatively connected to said control unit for outputting individual state changes of a digital output signal based on the mutual relationship between said measuring voltage and said reference voltage.

Thus, the present invention is based on the understanding that by utilizing individual digital input signal pulses as well as individual digital output signal pulses caused thereby, possibility is obtained of determining the mutual position between a first object and a second object with large time and location resolution as well as low energy consumption.

According to a preferred embodiment of the present invention, said first state change of the output signal from the comparator is an upflank of a digital output signal pulse, and wherein said second state change of the output signal from the comparator is a downflank of said digital output signal pulse.

According to a preferred embodiment, the sensor circuit of the position sensor assembly comprises a feedback branch connected between the output of the comparator and the second input of the comparator. This means that, upon state change of the output signal from the comparator, the determination of the mutual position is facilitated as a consequence of the state change being ensured and multiple fast state changes caused by electrical noise, etc., are eliminated.

Preferably, the first body of the position sensor assembly is displaceable in relation to said second body by being turnable about a pivot.

Further advantages and features of the invention are evident from the other dependent claims as well as in the following, detailed description of preferred embodiments.

### BRIEF DESCRIPTION OF THE DRAWINGS

A more complete understanding of the above-mentioned and other features and advantages of the present invention will be clear from the following, detailed description of preferred embodiments, reference being made to the accompanying drawings, wherein:

FIG. 1 is a schematic cross-sectional view of a first embodiment of the first body and the second body,

FIG. 2 is a schematic cross-sectional view of a second embodiment of the first body and the second body,

FIG. 3 is a schematic cross-sectional view of a third embodiment of the first body and the second body,

FIG. 4 is a schematic cross-sectional view of a forth embodiment of the first body and the second body,

FIG. 5 is a schematic cross-sectional view of a fifth embodiment of the first body and the second body,

FIG. 6 is a schematic representation of a sensor circuit according to a first embodiment,

FIG. 7 is a schematic representation of a sensor circuit according to a second embodiment,

FIG. 8 is a schematic representation of a sensor circuit according to a third embodiment,

FIG. 9 is a schematic representation of a sensor circuit according to a fourth embodiment,

FIG. 10 is a schematic representation of a sensor circuit according to a fifth embodiment, and

FIG. 11 is a schematic representation of a sensor circuit according to a sixth embodiment.

### DETAILED DESCRIPTION OF PREFERRED EMBODIMENTS

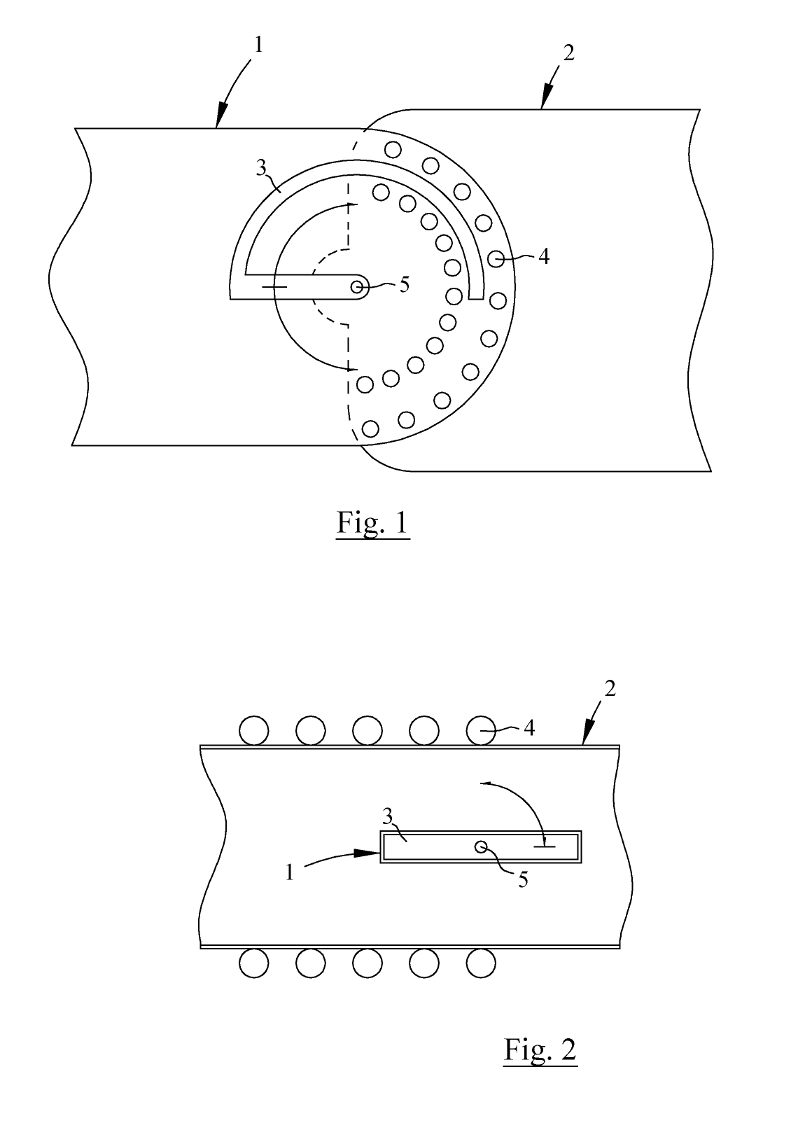

Reference is initially made to FIGS. 1-5, which schematically disclose different applications comprising the present invention. The present invention relates generally to a method and position sensor assembly for determining a mutual position between a first object 1 and a second object 2, see FIG. 1. In the application shown in FIG. 1, the first object 1 is constituted by a first arm and the second object 2 by a second arm, of for instance a assembling robot (not shown). The first object 1 and the second object 2 are mutually displaceable, and it shall be realized that the first object 1 and the second object 2 may jointly be displaced in relation to a third object (not shown). The third object may for instance be a stationary part of the assembling robot.

The first object 1 and the second object 2 are mutually displaceable in relation to each other, however, the present invention will be described in connection with the determination of mutual position between a first movable object 1 and a stationary second object 2 without being limited thereto.

A position sensor assembly is arranged to determine the mutual position between the first object 1 and the second object 2, i.e., determine where the first object 1 is located in relation to the second object 2.

In FIGS. 1-5 a first body 3 and a second body 4 are shown, which are mutually displaceable in relation to each other and said second body 4 presenting an unambiguous inductance value for each mutual position between said first body 3 and said second body 4. The first body 3 is connectable with the first object 1 and is arranged to be displaced jointly with the first object 1, and the second body 4 is connectable with the second object 2 and is arranged to be displaced jointly with the second object 2. Preferably the second body is constituted by an inductor, and most preferably by a coil such as shown in FIGS. 1-5.

In FIG. 1 the first body 3 is constituted by an arc shaped segment, and the first body 3 is arranged to be turned about a pivot 5. The second body 4 is constituted by a coil that is bend correspondingly as the first body 3. Upon turning of the arc segment about the pivot 5, the arc segment is displaced in relation to the coil, preferably internally of said coil, whereupon the inductance of the second body 4 is changed. It shall be realized that alternatively the first body 3 may stand still and the second body 4 may be turned about the picot 5, and it shall be pointed out that this applies to all embodiments. In FIG. 1 the first body 3 may be turned 180 degrees about the pivot 5 while unambiguous values of the inductance of the second body 4 are obtained.

In FIG. 2 the first object 3 is constituted by a valve body or a disc, arranged in the second object 2 that is constituted by a pipe/conduit. The second body 4 is arranged externally or internally of the second object 2. The first body 3 is arranged to be turned about the pivot 5, and upon turning of the first body 3 the inductance of the second body 4 is altered. In FIG. 2 the first body 3 may be turned 90 degrees about the pivot 5 while unambiguous values of the inductance of the second body 4 are obtained.

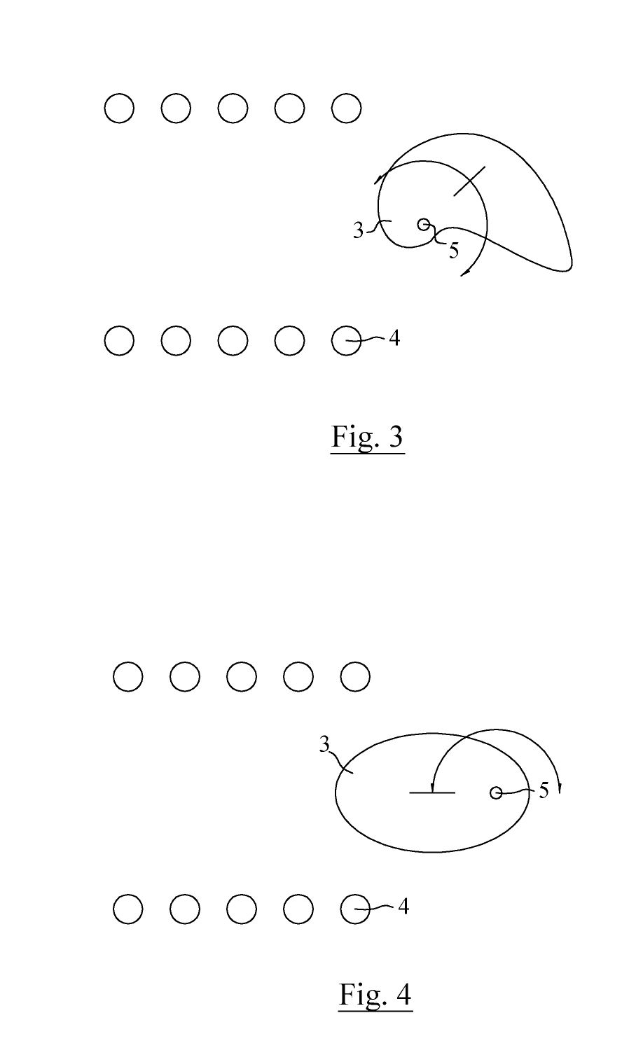

In FIGS. 3 and 4 alternative embodiments of the first body 3 are shown, which upon turning about the pivot 5 alters the inductance of the second body 4. In FIG. 3 the first body 3 may be turned 360 degrees about the pivot 5, and in FIG. 4 the first body may be turned 180 degrees about the pivot 5, while unambiguous values of the inductance of the second body 4 are obtained.

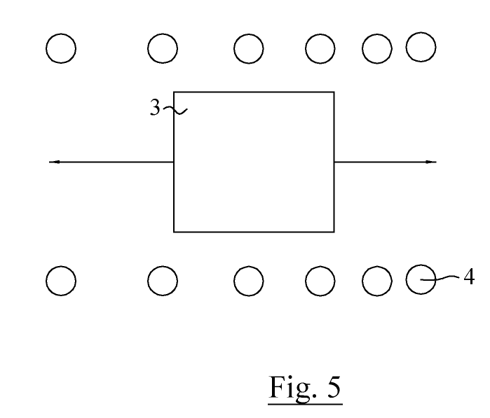

In FIG. 5 a fifth embodiment is shown in which the second body 4 is non-uniform and the first body 3 is arranged to be fully surrounded by the second body 4, a mutual axial displacement of the first body 3 and the second body 4 entailing that the inductance of the second body 4 is altered.

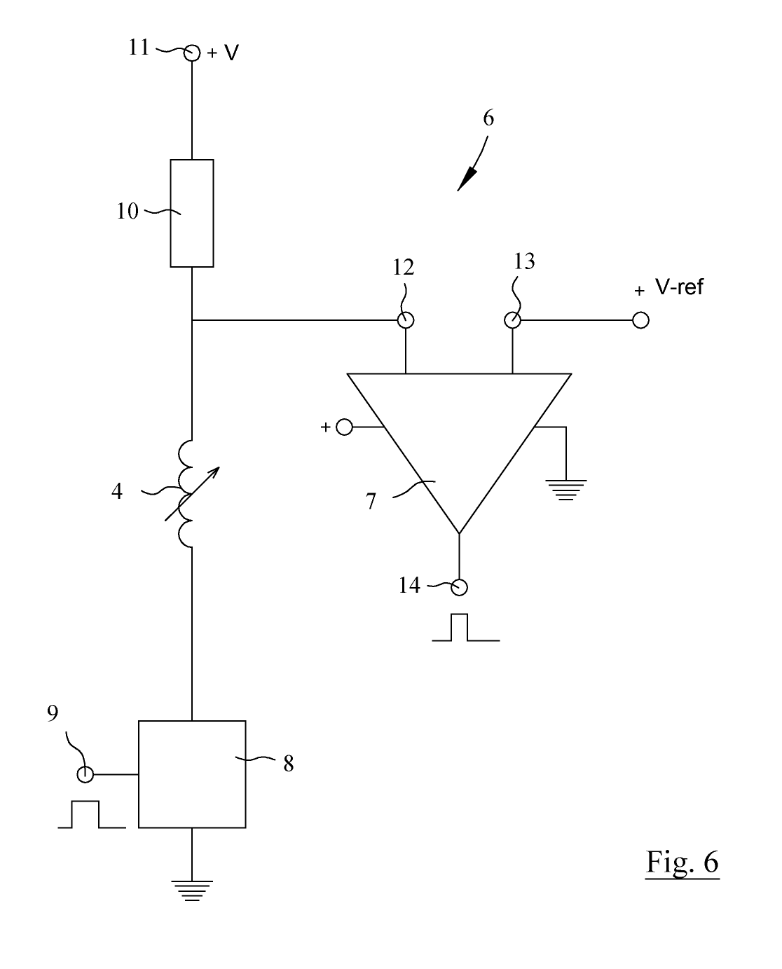

Reference is now also made to FIG. 6, which shows a schematic representation of a sensor circuit according to a first embodiment. The position sensor assembly comprises the first body 3 connectable to said first object 1, the second body 4, for instance a coil or inductor, connectable to said second object 2, a control unit (not shown), and a sensor circuit, generally designated 6.

The first body 3 is constituted by an electrically conductive body, preferably manufactured from a non-magnetic metal, such as aluminum. However, it is feasible that said first body 3 is manufactured from a magnetic metal, such as a compressed iron powder body. It shall be pointed out that the first body 3 may constitute the first object 1.

The second body 4 will hereinbelow be referred to as coil 4.

The coil 4 is preferably arranged in a seat (not shown) of the second object 2. The coil 4 is preferably manufactured by copper and comprises a large number of windings.

The sensor circuit 6 comprises a first branch and a comparator 7. The first branch of the sensor circuit 6 comprises said coil 4, a power switch 8 having an input 9 operatively connected to said control unit for inputting individual digital input signal pulses, and a measuring resistance 10, the coil 4, the power switch 8, and the measuring resistance 10 being coupled in series with each other. Furthermore, said first branch is connected between a voltage source 11 and ground, which voltage source 11 preferably is approximately +5 V. It should be pointed out that said coil may consist of two coils connected in series, a first coil of which belongs to a first valve and a second coil belongs to a second valve, provided that the first valve and the second valve does not have overlapping valve lift curves.

The comparator 7 of the sensor circuit 6 is connected to said first branch via a first input 12 to obtain an instantaneous measuring voltage across the measuring resistance 10, and comprises a second input 13 to obtain an instantaneous reference voltage and an output 14 operatively connected to said control unit for outputting individual state changes of a digital output signal.

The comparator 7 is arranged to obtain and compare instantaneous measuring voltage across the measuring resistance 10 and instantaneous reference voltage, and is arranged to, based on the mutual relationship between the measuring voltage and reference voltage, generate a state change of the digital output signal. A state change of the digital output signal from the output 14 of the comparator 7 is generated when the measuring voltage and reference voltage mutually change magnitude rank, i.e., mutually change order regarding which value that is greatest among them.

The position sensor assembly operates in the following way. When the first body 3 is displaced/turned in relation to the coil 4 the overlap between the first body 3 and the coil 4 (more precisely the magnet field of the coil 4) is changed, and when the influence from the first body 3 on the magnet field of the coil 4 is increased the time elapsed for the measuring voltage to be changed a predetermined value decreases in proportion thereto, as a consequence of the coil 4 being short-circuited to different degrees by the impact from the first body 3. The measuring voltage across the measuring resistance 10 is changed when the voltage across the coil 4 is changed, and the voltage across the coil 4 is changed as a consequence of a state change of the power switch 8 from open to closed taking place.

Within the scope of the common inventive concept of the present invention, said duration of change may be determined according to two methods, which methods give a consistent contribution to the prior art, but which are realizations of the same fundamental idea that is not suitable to be defined unanimously.

According to the first method, the method according to the invention comprises the steps of: sending an upflank, or positive flank, of a digital input signal pulse from the control unit to the power switch 8 to produce a state change of the power switch 8 from open to closed; detecting a first state change of the output signal from the comparator 7, and; determining a mutual position between said first body 3 and said coil 4 based on the time delay between the upflank of the input signal pulse and the first state change of the output signal.

According to the second method, the method according to the invention comprises the steps of: sending an upflank of a digital input signal pulse from the control unit to the power switch 8 to produce a state change of the power switch 8 from open to closed; detecting a first state change of the output signal from the comparator 7; detecting a second state change of said output signal, and; determining a mutual position between said first body 3 and said coil 4 based on the time delay between the first state change of the output signal and the second state change of the output signal.

The above-mentioned first method is based on a sensor circuit design wherein there is a time delay between the upflank of the input signal pulse and the first state change of the output signal. The above-mentioned second method is instead based on a sensor circuit design wherein the upflank of the input signal pulse and the first state change of the output signal take place together.

Preferably, said first state change of the output signal from the comparator 7 is an upflank of a digital output signal pulse, said second state change of the output signal from the comparator 7 being a downflank of said digital output signal pulse.

According to a preferred embodiment, the above-mentioned first method also comprises the step of, based on the detection of said first state change of the output signal from the comparator 7, sending a downflank, or negative flank, of said digital input signal pulse from the control unit to the power switch 8 to produce a state change of the power switch 8 from closed to open. According to a preferred embodiment, the above-mentioned second method also comprises the step of, based on the detection of said second state change of the output signal from the comparator 7, sending a downflank of said digital input signal pulse from the control unit to the power switch 8 to produce a state change of the power switch 8 from closed to open. In other words, the duration of the digital input signal pulse should be held as short as possible to save energy.

A large advantage of the present invention is that the determination of the mutual position between the first object 1 and the second object 2 can be selected to only be made when there is a reason to determine the mutual position, i.e., when the first object 1 is in motion.

Hereinbelow, a number of realizations of the sensor circuit 6 of the position sensor assembly will be described, which all have in common that the sensor circuit 6 comprises a second branch connected between the voltage source 11 and ground and comprising a first reference resistance 15 and a second reference resistance 16, which are coupled in series with each other, the second input 13 of the comparator 7 being connected to said second branch at a point situated between said first reference resistance 15 and said second reference resistance 16. Furthermore, the first input 12 of the comparator 7 is connected to said first branch at a point situated between said measuring resistance 10 and the coil 4.

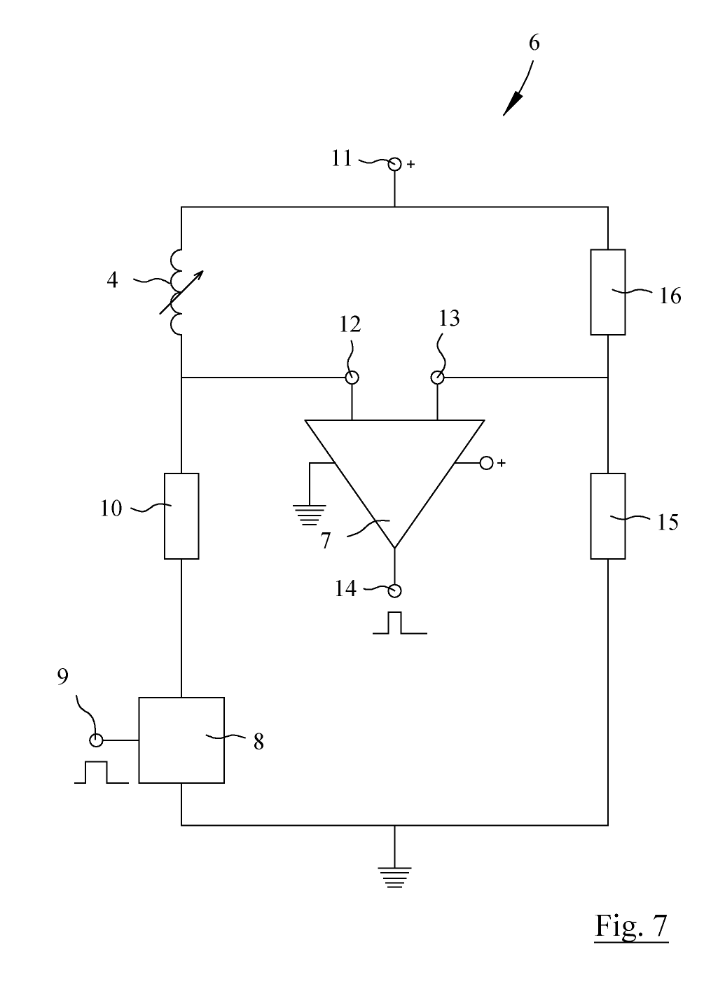

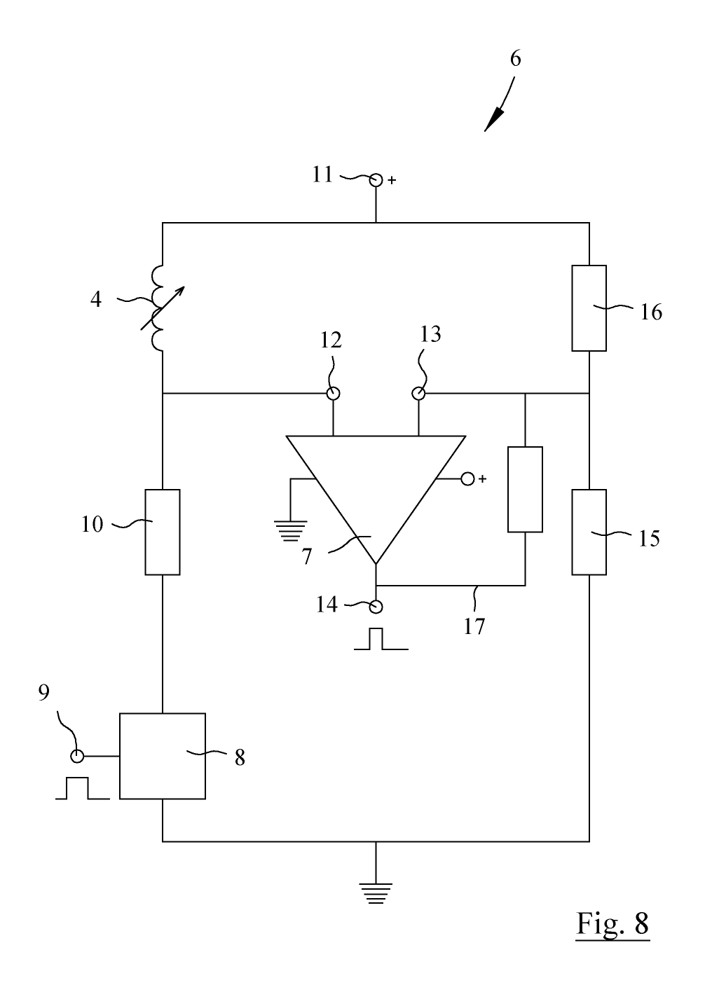

In order to function according to the above-mentioned first method, the sensor circuit 6 may, for instance, be realized in accordance with FIG. 7, which shows a schematic representation of the sensor circuit 6 according to a second embodiment, or in accordance with FIG. 8, which shows a schematic representation of the sensor circuit 6 according to a third embodiment. Common to these embodiments is that the coil 4 is situated between the voltage source 11 and the point on the first branch that is connected to the first input 12 of the comparator 7. It should be pointed out that the position of the power switch 8 in relation to the coil 4 and the measuring resistance 10 is freely selectable. In the third embodiment shown in FIG. 8, the sensor circuit 6 comprises, in addition to what is shown in the second embodiment according to FIG. 7, a feedback branch 17, or amplification branch, connected between the output 14 of the comparator 7 and the second input 13 of the comparator 7, in order to ensure the state change of the output signal of the comparator 7 for eliminating multiple fast state changes caused by electrical noise, etc.

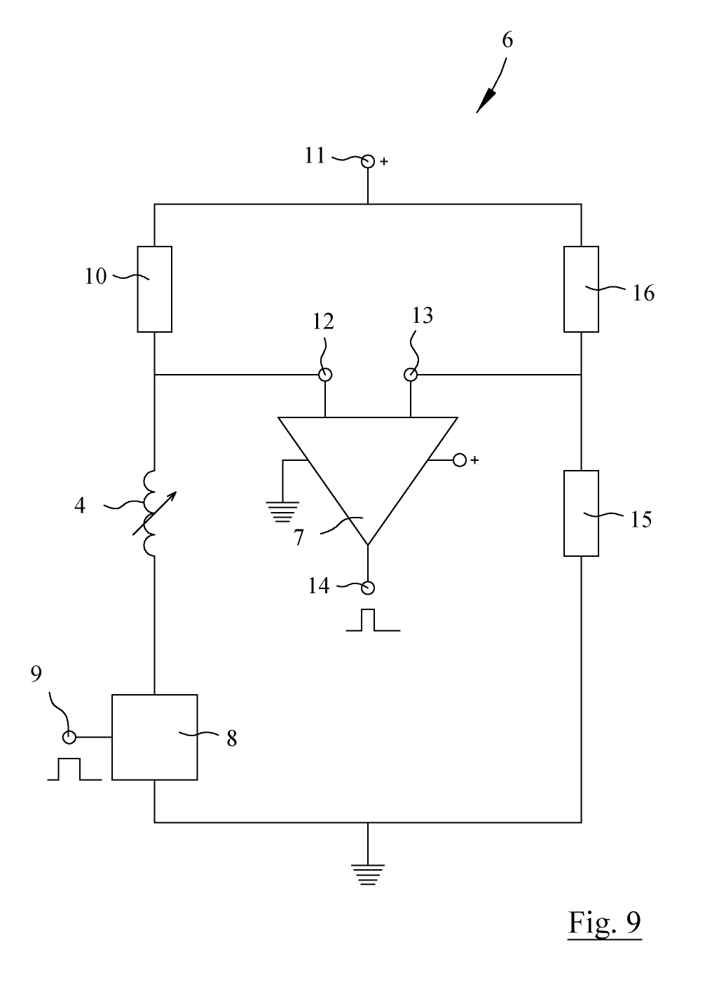

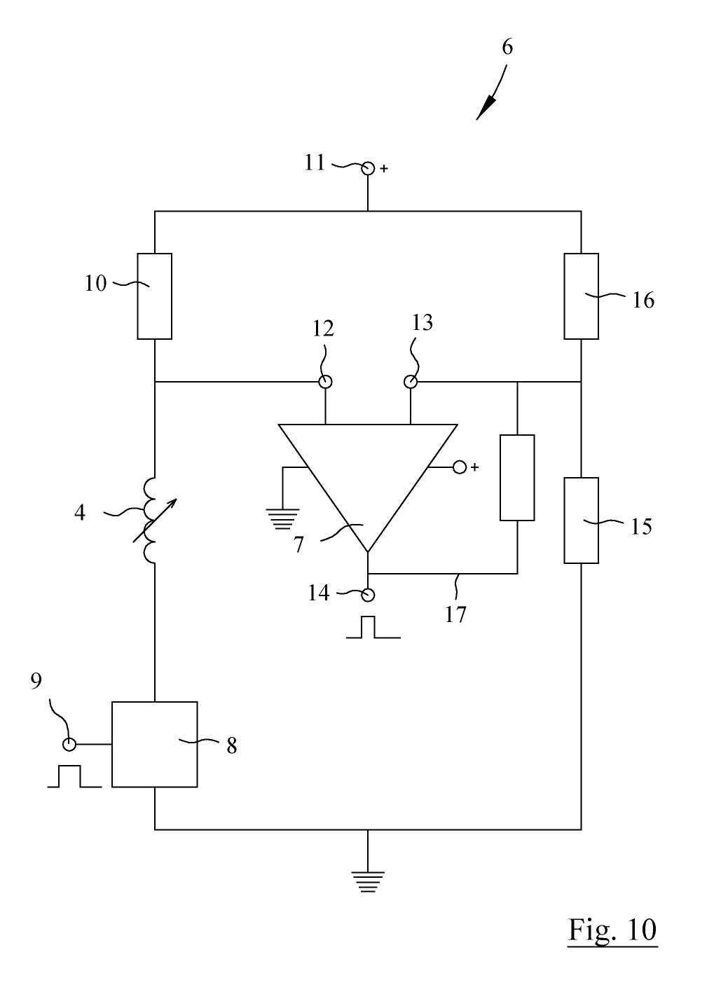

In order to function according to the above-mentioned second method, the sensor circuit 6 may, for instance, be realized in accordance with FIG. 9, which shows a schematic representation of the sensor circuit 6 according to a fourth embodiment, or in accordance with FIG. 10, which shows a schematic representation of the sensor circuit 6 according to a fifth embodiment. Common to these embodiments is that the measuring resistance 10 is situated between the voltage source 11 and the point on the first branch that is connected to the first input 12 of the comparator 7. It should be pointed out that the position of the power switch 8 in relation to the coil 4 and the measuring resistance 10 is freely selectable. In the fourth embodiment, shown in FIG. 9, the sensor circuit 6 comprises, in addition to what is shown in the fifth embodiment according to FIG. 10, a feedback branch 17, or amplification branch, connected between the output 14 of the comparator 7 and the second input 13 of the comparator 7.

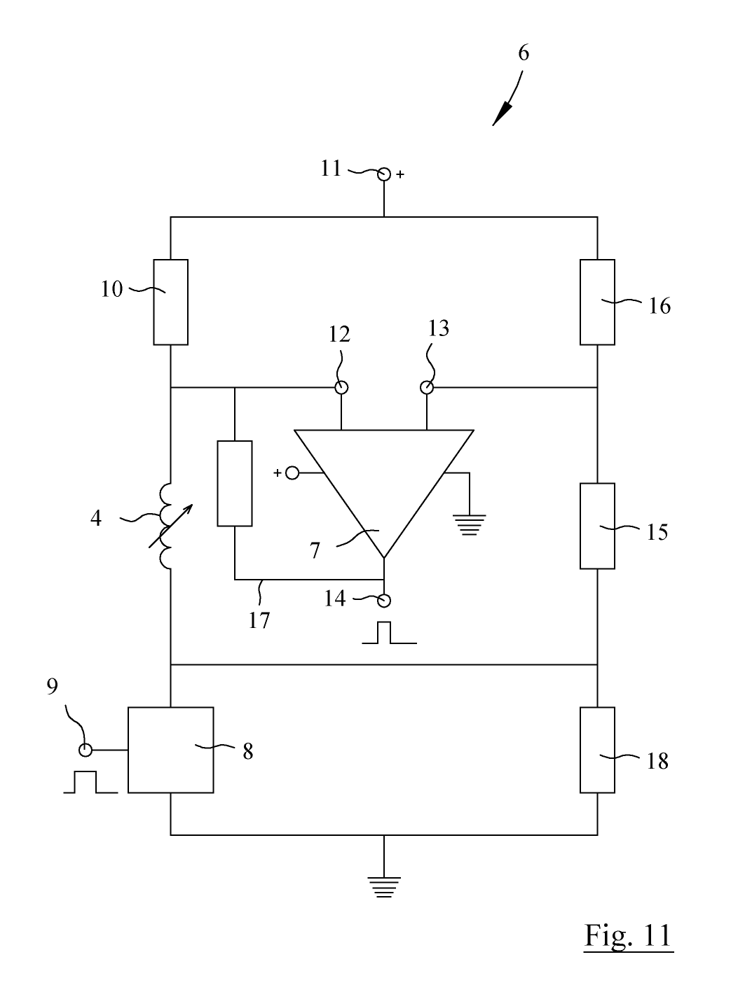

In FIG. 11, a schematic representation of the sensor circuit 6 according to a sixth embodiment is found, which sensor circuit is realized to function according to the above-mentioned second method. In this embodiment, the sensor circuit comprises a feedback branch 17, or amplification branch, connected between the output 14 of the comparator 7 and the first input 12 of the comparator 7, and the measuring resistance 10 is situated between the voltage source 11 and the point on the first branch that is connected to the first input 12 of the comparator 7. Furthermore, the power switch 8 is disposed adjacent to ground, as well as that the sensor circuit 6 comprises a synchronization resistance 18 that is connected in parallel across the power switch 8, each of the first branch and the second branch of the sensor circuit 6 being coupled in series with the synchronization resistance 18 as well as the power switch 8.

### Feasible Modifications of the Invention

The invention is not limited only to the embodiments described above and shown in the drawings, which only have illustrating and exemplifying purpose. This patent application is intended to cover all adaptations and variants of the preferred embodiments described herein, and consequently the present invention is defined by the wording of the accompanying claims and the equipment may accordingly be modified in all feasible ways within the scope of the accompanying claims.

It should also be pointed out that all information about/regarding terms such as above, below, upper, under, etc., should be interpreted/read with the equipment orientated in accordance with the figures, with the drawings orientated in such a way that the reference numbers can be read in a proper way. Accordingly, such terms only indicate mutual relationships in the shown embodiments, which relationships may be changed if the equipment according to the invention is provided with another construction/design.

It should be pointed out that even if it is not explicitly mentioned that features from one specific embodiment can be combined with the features of another embodiment, this should be regarded as evident when possible.

1. Method for determining a mutual position between a first body (3) and a second body (4) by means of a position sensor assembly, said first body (3) and said second body (4) being mutually displaceable in relation to each other and said second body (4) presenting an unambiguous inductance value for each mutual position between said first body (3) and said second body (4), which position sensor assembly comprises said first body (3), said second body (4), a control unit, and a sensor circuit (6), the sensor circuit (6) comprising a comparator (7) connected to a first branch comprising said second body (4), a power switch (8), and a measuring resistance (10) coupled in series with each other, the comparator (7) being arranged to obtain and compare an instantaneous measuring voltage across the measuring resistance (10) and an instantaneous reference voltage, and being arranged to, based on the mutual relationship between the measuring voltage and reference voltage, generate a state change of a digital output signal, the method comprising the steps of:
sending an upflank of a digital input signal pulse from the control unit to the power switch (8) to produce a state change of the power switch (8) from open to closed,
in the control unit, detecting a first state change of the output signal from the comparator (7), and
determining a mutual position between said first body (3) and said second body (4) based on the time delay between the upflank of the input signal pulse and the first state change of the output signal,
or comprising the steps of:
sending an upflank of a digital input signal pulse from the control unit to the power switch (8) to produce a state change of the power switch (8) from open to closed,
in the control unit, detecting a first state change of the output signal from the comparator (7),
in the control unit, detecting a second state change of said output signal, and
determining a mutual position between said first body (3) and said second body (4) based on the time delay between the first state change of the output signal and the second state change of the output signal.

2. Method according to claim 1, wherein said first state change of the output signal from the comparator (7) is an upflank of a digital output signal pulse, and wherein said second state change of the output signal from the comparator (7) is a downflank of said digital output signal pulse.

3. Method according to claim 1, wherein the method, in addition to the steps of:
sending an upflank of a digital input signal pulse from the control unit to the power switch (8) to produce a state change of the power switch (8) from open to closed,
in the control unit, detecting a first state change of the output signal from the comparator (7), and
determining a mutual position between said first body (3) and said second body (4) based on the time delay between the upflank of the input signal pulse and the first state change of the output signal, also comprises the step of:
based on the detection of said first state change of the output signal from the comparator (7), sending a downflank of said digital input signal pulse from the control unit to the power switch (8) to produce a state change of the power switch (8) from closed to open.

4. Method according to claim 1, wherein the method, in addition to the steps of:
sending an upflank of a digital input signal pulse from the control unit to the power switch (8) to produce a state change of the power switch (8) from open to closed,
in the control unit, detecting a first state change of the output signal from the comparator (7),
in the control unit, detecting a second state change of said output signal, and
determining a mutual position between said first body (3) and said second body (4) based on the time delay between the first state change of the output signal and the second state change of the output signal, also comprises the step of:
based on the detection of said second state change of the output signal from the comparator (7), sending a downflank of said digital input signal pulse from the control unit to the power switch (8) to produce a state change of the power switch (8) from closed to open.

5. Position sensor assembly for determining a mutual position between a first object (1) and a second object (2), which position sensor assembly comprises:
a first body (3) connectable to said first object (1), a second body (4) connectable to said second object (2), a control unit, and a sensor circuit (6), said first body (3) and said second body (4) being mutually displaceable in relation to each other and said second body (4) presenting an unambiguous inductance value for each mutual position between said first body (3) and said second body (4),
the sensor circuit (6) comprises:
a first branch comprising said second body (4), a power switch (8) having an input operatively connected to said control unit for receiving individual digital input signal pulses, and a measuring resistance (10), the second body (4), the power switch (8), and the measuring resistance (10) being coupled in series with each other,
a comparator (7), which is connected to said first branch via a first input (12) to obtain an instantaneous measuring voltage across the measuring resistance (10), and which further comprises a second input (13) for obtaining an instantaneous reference voltage, and an output (14) operatively connected to said control unit for outputting individual state changes of a digital output signal based on the mutual relationship between said measuring voltage and said reference voltage.

6. Position sensor assembly according to claim 5, wherein the sensor circuit (6) comprises a feedback branch (17) connected between the output (14) of the comparator (7) and the second input (13) of the comparator (7).

7. Position sensor assembly according to claim 5, wherein the first branch of the sensor circuit (6) is connected between a voltage source (11) and ground, and wherein the sensor circuit (6) comprises a second branch, which is connected between the voltage source (11) and ground, and which comprises a first reference resistance (15) and a second reference resistance (16), which are coupled in series with each other, the second input (13) of the comparator (7) being connected to said second branch at a point situated between said first reference resistance (15) and said second reference resistance (16).

8. Position sensor assembly according to claim 7, wherein the power switch (8) is disposed adjacent to ground.

9. Position sensor assembly according to claim 8, wherein the sensor circuit (6) comprises a synchronization resistance (18) that is connected in parallel across the power switch (8), each of the first branch and the second branch of the sensor circuit (6) being coupled in series with the synchronization resistance (18) as well as the power switch (8).

10. Position sensor assembly according to claim 5, wherein said first body (3) is an electrically conductive body, preferably manufactured from aluminum.

11. Position sensor assembly according to claim 5, wherein said first body (3) is displaceable in relation to said second body (4).

12. Position sensor assembly according to claim 10, wherein said first body (3) is turnable about a pivot (5).

13. Position sensor assembly according to claim 5, wherein said second body (4) is constituted by a coil.

14. Method according to claim 2, wherein the method, in addition to the steps of:
sending an upflank of a digital input signal pulse from the control unit to the power switch (8) to produce a state change of the power switch (8) from open to closed,
in the control unit, detecting a first state change of the output signal from the comparator (7),
in the control unit, detecting a second state change of said output signal, and
determining a mutual position between said first body (3) and said second body (4) based on the time delay between the first state change of the output signal and the second state change of the output signal,
also comprises the step of:
based on the detection of said second state change of the output signal from the comparator (7), sending a downflank of said digital input signal pulse from the control unit to the power switch (8) to produce a state change of the power switch (8) from closed to open.

15. Position sensor assembly according to claim 6, wherein the first branch of the sensor circuit (6) is connected between a voltage source (11) and ground, and wherein the sensor circuit (6) comprises a second branch, which is connected between the voltage source (11) and ground, and which comprises a first reference resistance (15) and a second reference resistance (16), which are coupled in series with each other, the second input (13) of the comparator (7) being connected to said second branch at a point situated between said first reference resistance (15) and said second reference resistance (16).

16. Position sensor assembly according to claim 15, wherein the power switch (8) is disposed adjacent to ground.

17. Position sensor assembly according to claim 6, wherein said first body (3) is an electrically conductive body, preferably manufactured from aluminum.

18. Position sensor assembly according to claim 6, wherein said first body (3) is displaceable in relation to said second body (4).

19. Position sensor assembly according to claim 6, wherein said second body (4) is constituted by a coil.
